(19) United States
(12) Patent Application Publication
(10) Pub. No.: US 2026/0357066 A1
(43) Pub. Date: Nov. 12, 2026

(54) Flame Resistant Thermoplastic Polymer Composition with Increased Thermal Shock Resistance

(71) Applicant: Celanese International Corporation, Irving, TX (US)

(72) Inventors: Jiqing He, Shanghai (CN); Ling Hong Wu, Shanghai (CN); Stephan Eilbracht, Prevessin-Moens (FR)

(21) Appl. No.: 19/673,179

(22) Filed: May 11, 2026

Related U.S. Application Data
(60) Provisional application No. 63/919,696, filed on Nov. 18, 2025.

(30) Foreign Application Priority Data
May 12, 2025 (WO) PCT/CN2025/094358

(51) Int. Cl. C08L 77/06; C08K 3/22; C08K 3/32; C08K 3/38; C08K 7/14

(52) U.S. Cl. CPC C08L 77/06; C08K 3/22; C08K 3/32; C08K 3/38; C08K 7/14; C08K 2003/222; C08K 2003/2227; C08K 2201/004; C08L 2203/20

(57) ABSTRACT

A polymer composition is disclosed, particularly a polyamide composition, that has excellent flame resistance and thermal shock resistance. The composition also has excellent electrical insulation properties. The composition contains at least one polyamide polymer, optionally glass fibers, and a thermal cycling agent for increasing thermal shock resistance.

### BACKGROUND

Nylon-based materials are widely used in various industrial applications due to their excellent mechanical properties, chemical resistance, and ease of processing. In particular, nylon compositions are frequently utilized in overmolding processes, where plastic materials are molded over metal components to enhance structural integrity, provide electrical insulation, and improve aesthetics. However, formulating a nylon composition that is both flame-retardant and suitable for metal overmolding presents significant technical challenges, further compounded by the difficulty of achieving good thermal shock resistance.

Flame retardancy is a critical requirement for nylon applications in the electrical, automotive, and industrial sectors to enhance safety and comply with stringent regulatory standards such as UL 94 and IEC 60695. Traditional flame retardants, such as halogenated additives, effectively inhibit combustion but often compromise the mechanical properties of the base nylon material. In particular, incorporating flame-retardant additives can lead to increased brittleness and reduced impact strength, which negatively affect the shock resistance required for durable overmolded components. This challenge becomes even more pronounced when considering thermal shock resistance, as sudden temperature fluctuations can induce cracking, delamination, or warping in formulations that lack sufficient resilience.

Additionally, electrical insulation is a key property for nylon materials used in electronic and electrical applications. Some flame retardants, especially those based on carbon or other conductive fillers, can inadvertently degrade the dielectric performance of the material. Achieving a balance between flame retardancy and electrical insulating properties is therefore a significant material formulation challenge.

Another critical aspect of nylon formulations for metal overmolding is adhesion. Nylon must bond effectively with metal substrates to ensure structural integrity and durability of the overmolded product. However, many flame-retardant additives can alter the surface energy and flow characteristics of the nylon, leading to poor adhesion and potential delamination under mechanical or thermal stress. These adhesion challenges are exacerbated by thermal shock, as repeated exposure to rapid temperature changes can weaken the interface between the nylon and metal, further increasing the risk of failure.

Moreover, thermal stability and processing conditions further complicate the formulation of a flame-retardant nylon suitable for overmolding. Overmolding involves elevated processing temperatures that can degrade certain flame-retardant additives, resulting in discoloration, reduced mechanical properties, or compromised flame retardancy. Additionally, nylon's inherent moisture absorption can impact both mechanical performance and overmolding adhesion, particularly when hydrophilic flame-retardant additives are incorporated. The effects of moisture absorption, combined with thermal expansion mismatches between nylon and metal, can further reduce thermal shock resistance, making the material more susceptible to cracking or structural failure.

Accordingly, there is a need for an improved nylon composition that provides flame retardancy while maintaining impact resistance, thermal shock resistance, electrical insulation, and strong adhesion in metal overmolding applications. The present disclosure addresses these challenges by providing an optimized material formulation that meets the demanding performance requirements of such applications.

### SUMMARY

The present disclosure is directed to a polymer composition that exhibits superior flame retardancy, mechanical performance, and thermal shock resistance, making it particularly suitable for metal overmolding applications. The polymer composition comprises a thermoplastic polymer present in an amount greater than about 35% by weight, with the thermoplastic polymer comprising one or more polyamide polymers. The polymer composition includes a flame retardant composition containing a non-halogen flame retardant, along with reinforcing fibers dispersed throughout the polymer matrix. Additionally, a thermal cycling agent comprising a silicone is incorporated to enhance thermal shock resistance.

The polymer composition demonstrates a comparative tracking index of at least 500 V, a V-0 rating when tested according to Underwriters Laboratories Test 94 under a Vertical Burn Test at a thickness of 1.5 mm, and a thermal shock resistance of greater than about 450 cycles at a temperature range of −40 °C to 140 °C. In certain embodiments, the polymer composition displays a comparative tracking index of at least 525 V, such as at least 550 V, at least 575 V, or at least 600 V. Furthermore, the polymer composition may exhibit a thermal shock resistance of greater than about 500 cycles, 600 cycles, or even 700 cycles under the specified temperature range.

The thermal cycling agent comprises an ultra-high molecular weight silicone and is present in the polymer composition in an amount from about 0.1% by weight to about 1.75% by weight. The ultra-high molecular weight silicone may comprise a polydimethylsiloxane and can be introduced into the polymer composition as a masterbatch containing a carrier polymer, such as a polyamide.

Reinforcing fibers, particularly glass fibers, are incorporated into the composition to enhance mechanical properties. The fibers have an average length of about 1 mm to about 5 mm and an average diameter of about 8 microns to about 15 microns. The glass fibers may be present in amounts ranging from about 5% to about 55% by weight, preferably from about 10% to about 45% by weight. Additionally, the glass fibers may contain silicon dioxide in amounts greater than 60% by weight and aluminum oxide in amounts greater than 16% by weight, while also containing boron oxide in amounts less than 5% by weight and magnesium oxide in amounts from about 3% to about 10% by weight.

The flame retardant composition preferably includes a metal phosphinate and may further incorporate a nitrogen-containing synergist to enhance flame retardancy. The polymer matrix comprises aliphatic polyamide polymers, including polyamide 66, polyamide 6, or mixtures thereof. In some embodiments, a mixture of polyamide 66 and polyamide 6 is utilized, with polyamide 66 present in an amount from about 25% to about 60% by weight and polyamide 6 in an amount from about 5% to about 25% by weight.

The polymer composition is designed to maintain high performance in demanding applications. The polymer composition can exhibit a V-0 rating under UL94 testing at a thickness of 0.8 mm, a notched Charpy impact resistance of greater than about 9 kJ/m², and a tensile stress at break of greater than about 145 MPa, such as greater than about 150 MPa.

The disclosure further encompasses composite structures comprising a metal component in contact with a resinous component that includes the disclosed polymer composition. The metal component may be overmolded with the polymer composition. These composite structures are applicable in various industries and can be utilized in busbars, current sensors, inverter filters, electrical connectors, brushless direct current motors, guide rings, and battery cell sealing rings. Additionally, the composite structures may include quick connectors, tees, interconnectors, and other related components.

The polymer composition and its applications provide a robust solution for high-performance, flame-retardant, and thermally stable overmolded metal-polymer composite structures.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 illustrates an electric vehicle including components that may incorporate a polymer composition as disclosed herein;

FIG. 2 illustrates one embodiment of a busbar as may incorporate a polymer composition as disclosed herein;

FIG. 3 illustrates a battery assembly that may employ components that may incorporate a polymer composition as disclosed herein;

FIG. 4 is a perspective view of one embodiment of a connector that may incorporate a polymer composition as disclosed herein;

FIG. 5 is a plan view of the connector of FIG. 4 in which the first and second connector portions are disengaged;

FIG. 6 is a plan view of the connector of FIG. 4 in which the first and second connector portions are engaged;

FIG. 7 illustrates examples of components that may incorporate a polymer composition as disclosed herein;

FIG. 8 illustrates additional components that may incorporate a polymer composition as disclosed herein;

FIG. 9 illustrates one embodiment of a water pump as may incorporate a polymer composition as disclosed herein; and

FIGS. 10-13 illustrate sample components that may be used to perform testing for thermal shock resistance as described herein.

Repeat use of reference characters in the present specification and drawings is intended to represent the same or analogous features or elements of the present invention.

### DEFINITIONS

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. According to UL746A, a nominal part thickness of 3 mm is considered representative of performance at other thicknesses.

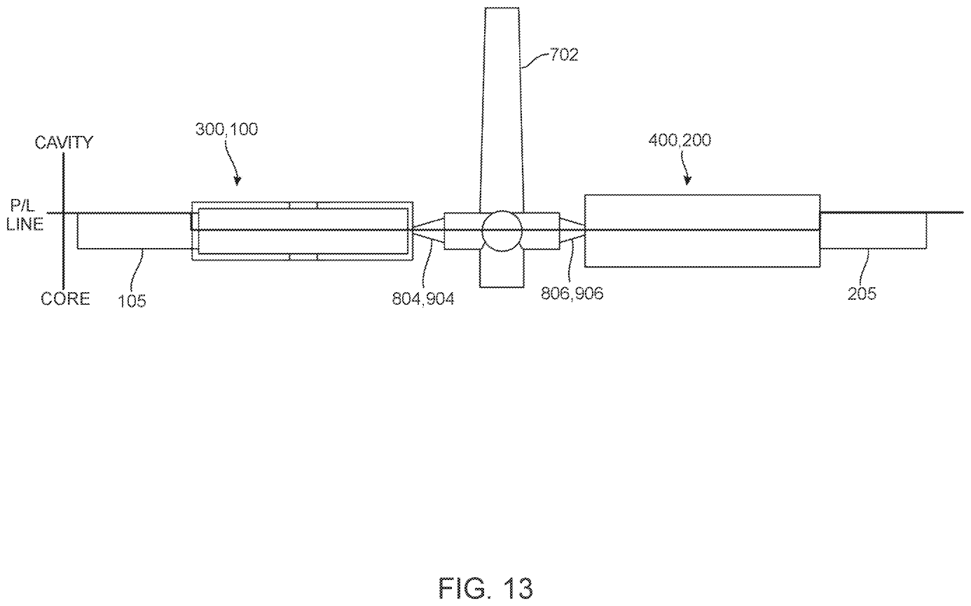

Thermal Shock Resistance: To test thermal shock resistance, four (4) types of sample components can be initially formed using the molds and inserts shown in FIGS. 10-13. As shown in FIG. 10, a first mold 100 is shaped to result in a plastic thickness of 1.2 mm and a part size of 63.8 mm×20 mm×10.4 mm; a second mold 200 is shaped to result in a plastic thickness of 2.5 mm and a part size of 65.1 mm×22.6 mm×13 mm; a third mold 300 is shaped to result in a plastic thickness of 1.2 mm and a part size of 40 mm×20 mm×10.4 mm; and a fourth mold 400 is shaped to result in a plastic thickness of 42.6 mm×22.6 mm×13 mm. Two circular bores 402 are formed on the cavity side of each of the molds 300 and 400, parallel to the longitudinal edge of the molds. The bores 402 have a diameter of 3.5 mm and are recessed into the cavity side of the molds. The first and second molds 100 and 200 contain metal inserts 105 and 205 (see FIG. 11), respectively, which are formed from an AISI H13/440C stainless steel sheet having a size of 62.6 mm×18 mm×18 mm that is inserted into the mold in a manner such that no weldline is formed. The inserts 105 and 205 have a single circular bore 502 at their respective ends having a diameter of 5 mm. The third and fourth molds 300 and 400 likewise contain metal inserts 305 and 405 (see FIG. 11), respectively, which are formed from an AISI H13/440C stainless steel sheet having a size of 37.6 mm×18 mm×18 mm. As shown in FIG. 11, each of the metal inserts 305 and 405 contain two circular bores 602 that are aligned parallel to the transverse edge of the inserts and recessed into the core side of each respective insert. The bores 602 have a diameter of 2.0 mm and are recessed into the core side of the inert by a depth of 5 mm. When inserted into the molds 300 and 400, a weldline is formed at a line where two flow fronts meet such that there is an inability of the flow fronts to “knit” or “weld” together during the molding process.

Referring to FIGS. 10, 12, and 13, a sample component may be formed using the molds described above by initially passing a polymer composition through a sprue 702 having an upper end 704 with a small diameter (i.e., 6 mm) and a lower end 706 with a diameter greater than the upper end 704 (i.e., 8 mm). The polymer composition may flow through the sprue 702 into a first runner 802 (diameter of 7 mm) and through a gate 804 for the third mold 300 that has a size of 0.8×10 mm and through a gate 806 for the fourth mold 400 that has a size of 1.7×10 mm. The polymer composition may likewise flow through the sprue 702 into a second runner 902 (diameter of 6 mm) and through a gate 904 for the first mold 100 that has a size of 0.8×10 mm and through a gate 906 for the fourth mold 400 that has a size of 1.7×10 mm. The draft angle for each side of the molds is 1.5°. When forming molded parts, the processing conditions may be selected as is known to those skilled in the art. For example, the melt and nozzle temperature may be 285 °C, the injection pressure may be 1250 bar, the peak pressure may be 1146 bar (e.g., for mold 100) and 1120 (e.g., for mold 300), the injection speed may be 80 mm/s and the injection time may be about 0.25 s, the hold pressure may be about 800 bar, the cooling time may be about 15 s, and the total cycle time may be about 23 s.

A set of twenty (20) sample components may be formed using each of the molds described above. The sample components may then be subjected to a first heating cycle within a thermal shock chamber having a hot zone and a cold zone, such as those commercially available under the name “ShockEvent T/120/V2” from Weisstechnik. The hot zone may be heated to a temperature of 140 °C and the cold zone may be cooled to a temperature of −40 °C. To initiate the first heating cycle, the sample components are placed within the hot zone for 30 minutes and then a product carrier within the chamber moves the sample components from the hot zone to the cold zone for an additional 30 minutes. In this manner, the total time of the first cycle is 1 hour. 24 cycles are conducted each day and 1 hour for each cycle. During the first two weeks, the sample components are visually observed for cracking once a day, and thereafter, the sample components are visually observed for cracking twice per week until all twenty (20) samples crack or a full set of cycles is achieved, which may be either 1,500 or 3,000 cycles depending on the testing protocol. When the first sample cracks, the number of cycles achieved prior to cracking is recorded as the “thermal shock resistance value.” If a full set of cycles (1,500 or 3,000) is achieved without all samples cracking, the “thermal shock resistance value” is simply recorded as “>1,500” or “>3,000”, depending on the particular testing protocol.

Unless otherwise specified, Thermal Shock Resistance is measured herein using the third mold 300.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm. The two sets are conditioned before and after aging. For unaged testing, each thickness is tested after conditioning for 48 hours at 23 °C and 50% relative humidity. For aged testing, five (5) samples of each thickness are tested after conditioning for 7 days at 70 °C.

| Vertical | |
|---|---|
| Ratings | Requirements |
| V-0 | Specimens must not burn with flaming combustion for more |
| | than 10 seconds after either test flame application. |
| | Total flaming combustion time must not exceed 50 seconds |
| | for each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 30 seconds after removal of the test flame. |
| V-1 | Specimens must not burn with flaming combustion for more |
| | than 30 seconds after either test flame application. |
| | Total flaming combustion time must not exceed 250 seconds |
| | for each set of 5 specimens. |
| | Specimens must not burn with flaming or glowing combustion |
| | up to the specimen holding clamp. |
| | Specimens must not drip flaming particles that ignite the cotton. |
| | No specimen can have glowing combustion remain for longer |
| | than 60 seconds after removal of the test flame. |
| V-2 | Specimens must not burn with flaming combustion for more |
| | than 30 seconds after either test flame application. |
| | Total flaming combustion time must not exceed 250 seconds |
| | for each set of 5 specimens. |
| | Specimens must not burn with flaming or glowing combustion |
| | up to the specimen holding clamp. |
| | Specimens can drip flaming particles that ignite the cotton. |
| | No specimen can have glowing combustion remain for longer |
| | than 60 seconds after removal of the test flame. |

Glass transition temperature and melting temperature: The glass transition temperature and the melting temperature may be determined using differential scanning calorimetry (“DSC”), using, for instance, ISO Test No. 11357-2:2013 (glass transition temperature) and 11357-3:2011 (melting temperature).

### DETAILED DESCRIPTION

It is to be understood by one of ordinary skill in the art that the present discussion is a description of exemplary embodiments only and is not intended as limiting the broader aspects of the present invention.

In general, the present disclosure is directed to a thermoplastic polymer composition that is particularly well suited for forming metal overmolded articles. The metal overmolded articles can comprise various electronic components, such as those used to construct an electric vehicle or hybrid vehicle. Metal overmolded parts made according to the present disclosure can also be used in all different types of electronic devices and systems.

The polymer composition of the present disclosure is formulated so as to not only display excellent flame resistant properties but also display thermal shock resistance. In addition, the polymer composition can also be formulated to display a high comparative tracking index.

In the past, problems were experienced in creating thermoplastic polymer compositions that not only had good flame resistant properties but also had good thermal shock resistance and electrical insulating properties. In particular, when components were added to the polymer composition for improving flame resistance, the components may adversely impact the thermal shock resistance and electrical insulating properties. Similarly, many modifiers used to improve thermal shock resistance can significantly degrade the fire resistant properties of the composition. Polymer compositions formulated according to the present disclosure, however, have unexpectedly found to have both excellent flame resistance in combination with excellent thermal shock resistance. In addition, and of significant advantage, the polymer composition can also display a relatively high comparative tracking index.

Thermal shock resistance is particularly desirable when producing metal overmolded parts in electrical systems. Metal overmolded parts, for instance, are widely used in battery management systems and in electric drive units in electric vehicles. The insulating polymer material that is used to coat a metallic part should provide good thermal shock resistance, which means that the polymer coating should show no cracks and maintain good electrical insulating properties after many thermal shock cycles. Polyamide polymers used in the past, for instance, have displayed a relatively poor thermal shock resistance. The present disclosure, however, overcomes the above problems experienced in the past.

The polymer composition of the present disclosure generally comprises a thermoplastic polymer, such as one or more polyamide polymers, that form a polymer matrix when molded into an article. The thermoplastic polymer is combined with a flame retardant system that can comprise a metal phosphinate in combination with a nitrogen-containing synergist. Optionally, the polymer composition can also contain reinforcing fibers, such as glass fibers. In accordance with the present disclosure, the polymer composition further includes a thermal cycling agent. The thermal cycling agent can comprise, for instance, an elastomeric polymer, such as a silicone polymer. The thermal cycling agent has been found to improve thermal shock resistance without degrading the flame resistant properties of the composition.

Polymer compositions formulated in accordance with the present disclosure, for instance, can display a thermal shock resistance when measured over a temperature range of from −40 °C to 140 °C of greater than about 400 cycles, such as greater than about 450 cycles, such as greater than about 500 cycles, such as greater than about 550 cycles, such as greater than about 600 cycles, such as greater than about 650 cycles, such as greater than about 700 cycles, such as greater than about 750 cycles, and generally less than about 3,000 cycles. In comparison, in the past, many polyamide 6 glass-reinforced compositions displayed a thermal shock resistance of less than 100 thermal cycles while many polyamide 66 glass-reinforced compositions displayed a thermal shock resistance of less than about 245 cycles.

In addition, the polymer composition of the present disclosure can be formulated so as to exhibit a V-0 rating as determined in accordance with UL 94 at a thickness of only 1.5 mm, such as only 0.8 mm, such as only 0.4 mm.

In addition to flame retardant properties and/or thermal shock resistance, the polymer composition of the present disclosure can also display excellent comparative tracking index properties. The comparative tracking index (CTI) is the maximum voltage, measured in volts, at which a material withstands 50 drops of contaminated water without tracking. Tracking is defined as the formation of conductive paths due to electrical stress, humidity, and contamination. The comparative tracking index test is an accelerated simulation to determine possible future failures that typically result in a short in electrical equipment using the polyamide polymer composition as an insulating material. Comparative tracking index can be measured according to Test IEC 60112:2020. The flame retardant polymer composition of the present disclosure can be formulated to display a comparative tracking index of 550 volts or more, such as 600 volts or more, such as 650 volts or more, such as 700 volts or more (and less than about 2000 volts).

The polymer composition of the present disclosure can also display excellent mechanical properties.

The polymer composition can display a Charpy notched impact strength at 23 °C of greater than about 7 kJ/m², such as greater than about 8 kJ/m², such as greater than about 9 kJ/m², such as greater than about 10 kJ/m², and generally less than about 40 kJ/m².

The polymer composition can display a tensile stress at break of greater than about 130 MPa, such as greater than about 145 MPa, such as greater than about 150 MPa, such as greater than about 155 MPa, and generally less than about 250 MPa. The polymer composition can display a tensile strain at break of greater than about 1.75%, such as greater than about 2%, such as greater than about 2.15%, and generally less than about 4%.

Due to the excellent flame resistance properties, excellent thermal shock resistance, and excellent mechanical properties, the polymer composition of the present disclosure is well suited for making all different types of articles and components.

The polymer composition is particularly well suited for producing all different types of electrical components. Such articles can include high voltage powertrain components and other devices that may be powered using lithium ion batteries. The polymer composition can serve as a housing for encasing the electrical component or can be an insulative component that directly surrounds an electrical contact pin or other conductive member. The present disclosure is particularly well suited for producing metal overmolded articles, such as inverters, converters, onboard charger bases, relay box frames, busbars, battery pack components, high voltage connectors, and the like.

The polymer composition of the present disclosure generally contains one or more polyamide polymers that form a polymer matrix when molded into articles. The polymer matrix functions as a continuous phase of the composition and contains one or more thermoplastic polymers. Thermoplastic polymers well suited for use in the composition include polyamide polymers, polyarylene sulfide polymers, polyester polymers, and mixtures thereof. The one or more thermoplastic polymers can be present in the polymer matrix in an amount from about 20% by weight to about 90% by weight, including all increments of 1% by weight therebetween. For example, one or more thermoplastic polymers can be contained in the polymer composition in an amount greater than about 25% by weight, such as in an amount greater than about 30% by weight, such as in an amount greater than about 35% by weight and generally in an amount less than about 85% by weight, such as in an amount less than about 80% by weight, such as in an amount less than about 70% by weight, such as in an amount less than about 60% by weight, such as in an amount less than about 50% by weight, such as in an amount less than about 45% by weight.

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed. When such a blend is employed, the weight ratio of nylon-6 to nylon-66 is typically from about 1:1 to about 1:8, such as from about 1:2 to about 1:6, such as from about 1:2.5 to about 1:5.

In one aspect, for instance, the polymer composition contains a nylon-66 polymer in an amount greater than about 10% by weight, such as in an amount greater than about 15% by weight, such as in an amount greater than about 20% by weight, such as in an amount greater than about 25% by weight, such as in an amount greater than about 30% by weight, such as in an amount greater than about 35% by weight, and in an amount less than about 65% by weight, such as in an amount less than about 55% by weight, such as in an amount less than about 50% by weight, such as in an amount less than about 45% by weight. The nylon-66 polymer can be combined with a nylon-6 polymer. The nylon-6 polymer, in one aspect, can be present in the polymer composition in an amount greater than about 5% by weight, such as in an amount greater than about 8% by weight, and in an amount less than about 55% by weight, such as in an amount less than about 30% by weight, such as in an amount less than about 18% by weight.

It is also possible to optionally include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one embodiment, the polymer composition contains primarily or only aliphatic polyamide polymers that may be blended with one or more semi-aromatic polyamide polymers or a wholly aromatic polyamide polymer.

The polyamide employed in the polymer composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220 °C or more, in some embodiments from about 240 °C to about 325 °C, and in some embodiments, from about 250 °C to about 335 °C. The polyamide may also have a relatively high glass transition temperature, such as about 30 °C or more, in some embodiments about 40 °C or more, and in some embodiments, from about 45 °C to about 140 °C.

In addition to one or more thermoplastic polymers, the polymer matrix may also contain a flame retardant system to help achieve the desired flammability performance. In one aspect, the flame retardant system of the present disclosure only contains two flame retardant components, although in other embodiments various other components may be added. Excellent flame resistant properties in combination with excellent melt processing characteristics can be obtained by incorporating into the polymer composition a non-halogen flame retardant in combination with a synergist.

In one embodiment, the flame retardant system of the present disclosure contains a metal phosphinate in combination with a synergist. In one aspect, the synergist can comprise a polyphosphate and/or a melamine or melamine derivative. The synergist, for instance, can comprise a nitrogen-containing polyphosphate, such as a melamine polyphosphate. In one aspect, the synergist can comprise a metal salt of a phosphonic acid, a phosphonic acid, or mixtures thereof.

The amount of flame retardant system incorporated into the polymer composition can vary depending upon the particular application and the desired result. In general, the flame retardant system is present in the polymer composition in an amount greater than about 12% by weight, such as in an amount of greater than about 15% by weight, such as in an amount greater than about 18% by weight, such as in an amount greater than about 20% by weight, such as in an amount of greater than about 21% by weight. The flame retardant system is generally present in the composition in an amount less than about 30% by weight, such as in an amount less than about 28% by weight, such as in an amount less than about 25% by weight.

As described above, the flame retardant system can include a phosphinate flame retardant, such as a metal phosphinate. Such phosphinates are typically salts of a phosphinic acid and/or diphosphinic acid, such as those having the general formula (I) and/or formula (II):

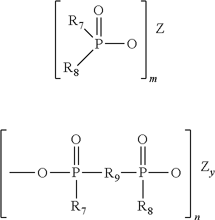

wherein,
R₇ and R₈ are, independently, hydrogen or substituted or unsubstituted, straight chain, branched, or cyclic hydrocarbon groups (e.g., alkyl, alkenyl, alkynyl, aralkyl, aryl, alkaryl, etc.) having 1 to 6 carbon atoms, particularly alkyl groups having 1 to 4 carbon atoms, such as methyl, ethyl, n-propyl, iso-propyl, n-butyl, or tert-butyl groups;
R₉ is a substituted or unsubstituted, straight chain, branched, or cyclic C₁-C₁₀ alkylene, arylene, arylalkylene, or alkylarylene group, such as a methylene, ethylene, n-propylene, iso-propylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, t-butylnaphthylene, phenylethylene, phenylpropylene or phenylbutylene group;
Z is Mg, Ca, Al, Sb, Sn, Ge, Ti, Zn, Fe, Zr, Ce, Bi, Sr, Mn, Li, Na, K, and/or a protonated nitrogen base;
y is from 1 to 4, and preferably 1 to 2 (e.g., 1);
n is from 1 to 4, and preferably 1 to 2 (e.g. 1); and
m is from 1 to 4 and preferably 1 to 2 (e.g., 2).

The phosphinates may be prepared using any known technique, such as by reacting a phosphinic acid with a metal carbonate, metal hydroxide, or metal oxides in aqueous solution. Particularly suitable phosphinates include, for example, metal salts of dimethylphosphinic acid, ethylmethylphosphinic acid, diethylphosphinic acid, methyl-n-propylphosphinic acid, methane-di(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid, hypophosphoric acid, etc. The resulting salts are typically monomeric compounds; however, polymeric phosphinates may also be formed. Particularly suitable metals for the salts may include Al and Zn. For instance, one particularly suitable phosphinate is zinc diethylphosphinate. Another particularly suitable phosphinate is aluminum diethylphosphinate.

One or more metal phosphinates can generally be present in the polymer composition in an amount greater than about 6% by weight, such as in an amount greater than about 8% by weight, such as in an amount greater than about 10% by weight. One or more metal phosphinates are generally present in the polymer composition in an amount less than about 20% by weight, such as in an amount less than about 18% by weight, such as in an amount less than about 15% by weight.

The metal phosphinate can be combined with a synergist. The synergist can comprise a melamine or a melamine derivative. In one embodiment, the synergist is a polyphosphate, such as a nitrogen-containing polyphosphate. The polyphosphate may have the following general formula:

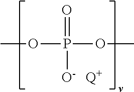

v is from 1 to 1000, in some embodiments from 2 to 500, in some embodiments from 3 to 100, and in some embodiments, from 5 to 50; and Q is a nitrogen base. Suitable nitrogen bases may include those having a substituted or unsubstituted ring structure, along with at least one nitrogen heteroatom in the ring structure (e.g., heterocyclic or heteroaryl group) and/or at least one nitrogen-containing functional group (e.g., amino, acylamino, etc.) substituted at a carbon atom and/or a heteroatom of the ring structure. Examples of such heterocyclic groups may include, for instance, pyrrolidine, imidazoline, pyrazolidine, oxazolidine, isoxazolidine, thiazolidine, isothiazolidine, piperidine, piperazine, thiomorpholine, etc. Likewise, examples of heteroaryl groups may include, for instance, pyrrole, imidazole, pyrazole, oxazole, isoxazole, thiazole, isothiazole, triazole, furazan, oxadiazole, tetrazole, pyridine, diazine, oxazine, triazine, tetrazine, and so forth. If desired, the ring structure of the base may also be substituted with one or more functional groups, such as acyl, acyloxy, acylamino, alkoxy, alkenyl, alkyl, amino, aryl, aryloxy, carboxyl, carboxyl ester, cycloalkyl, hydroxyl, halo, haloalkyl, heteroaryl, heterocyclyl, etc. Substitution may occur at a heteroatom and/or a carbon atom of the ring structure. For instance, one suitable nitrogen base may be a triazine in which one or more of the carbon atoms in the ring structure are substituted by an amino group. One particularly suitable base is melamine, which contains three carbon atoms in the ring structure substituted with an amino functional group. Such bases may form a melamine polyphosphate.

The synergist can generally be present in the polymer composition in an amount greater than about 3% by weight, such as in an amount greater than about 6% by weight, such as in an amount greater than about 7% by weight, such as in an amount greater than about 8% by weight, and generally less than about 20% by weight, such as in an amount less than about 15% by weight, such as in an amount less than about 12% by weight.

Optionally, the flame retardant system can also contain an inorganic compound. Suitable inorganic compounds (anhydrous or hydrates) may include, for instance, inorganic molybdates, such as zinc molybdate, calcium molybdate, ammonium octamolybdate, zinc molybdate-magnesium silicate, etc. Other suitable inorganic compounds may include inorganic borates, such as zinc borate, zinc phosphate, zinc hydrogen phosphate, zinc pyrophosphate, basic zinc chromate (VI) (zinc yellow), zinc chromite, zinc permanganate, silica, magnesium silicate, calcium silicate, calcium carbonate, titanium dioxide, magnesium dihydroxide, and so forth.

When present, one or more inorganic compounds can be present in the polymer composition in amounts less than about 2% by weight, such as in amounts less than about 1.5% by weight, such as in amounts less than about 1% by weight, such as in amounts less than about 0.9% by weight, and generally greater than about 0.05% by weight, such as greater than about 0.1% by weight, such as greater than about 0.2% by weight, such as greater than about 0.3% by weight.

The polymer composition can also contain reinforcing fibers. The reinforcing fibers can have a high degree of tensile strength relative to their mass. For example, the ultimate tensile strength of the fibers (determined in accordance with ASTM D2101) is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties.

The reinforcing fibers or glass fibers can generally have an average fiber length of greater than about 1 mm, such as greater than about 1.5 mm, such as greater than about 2 mm, such as greater than about 2.5 mm, and less than about 8 mm, such as less than about 7 mm, such as less than about 6 mm, such as less than about 5 mm, such as less than about 4.5 mm, such as less than about 4 mm, such as less than about 3 mm. After formation of the polymer composition, for example, the average length of the inorganic fibers may be relatively small, such as from about 10 to about 800 micrometers, in some embodiments from about 100 to about 700 micrometers, and in some embodiments, from about 200 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

In one embodiment, glass fibers can be used that have a relatively high modulus. It is believed that the higher glass modulus fibers may further improve thermal shock resistance. The glass fibers, for instance, can have a relatively high silica content and a relatively low boron oxide content. For instance, the fibers can have a silicon dioxide content of greater than about 60% by weight, such as greater than about 62% by weight, such as greater than about 64% by weight, and in an amount less than about 80% by weight, such as in an amount less than about 70% by weight, such as in an amount less than about 68% by weight. The glass fibers can be completely free of boron oxide or contain boron oxide in an amount less than about 5% by weight, such as in an amount less than about 4% by weight, such as in an amount less than about 3% by weight, such as in an amount less than about 2% by weight, such as in an amount less than about 1% by weight.

In addition to silicon dioxide and boron oxide, the glass fibers can contain aluminum oxide, calcium oxide, and magnesium oxide. Aluminum oxide can be present in the glass fibers in an amount greater than about 15% by weight, such as in an amount greater than about 16% by weight, such as in an amount greater than about 17% by weight, such as in an amount greater than about 18% by weight, and in an amount less than about 25% by weight, such as in an amount less than about 23% by weight, such as in an amount less than about 21% by weight. Calcium oxide can be present in the glass fibers in amounts less than about 15% by weight, such as in amounts less than about 12% by weight, such as in amounts less than about 10% by weight, such as in amounts less than about 8% by weight, and in an amount greater than about 5% by weight. Magnesium oxide can be present in an amount greater than about 3% by weight, such as in an amount greater than about 4% by weight, such as in an amount greater than about 5% by weight, such as in an amount greater than about 6% by weight, and in an amount less than about 10% by weight, such as in an amount less than about 8% by weight. The glass fibers can also contain alkali oxides in an amount less than about 2% by weight, such as sodium oxide, potassium oxide, or mixtures thereof.

The above blend of components produces glass fibers that have excellent thermal resistance with good strength properties and high temperature stability. The amount of boron contained in the fibers is limited in order to improve heat resistance. The glass fibers can display a flexural modulus of greater than about 86 GPa, such as greater than about 90 GPa, such as greater than about 93 GPa, such as greater than about 95 GPa, and less than about 130 GPa.

The amount of reinforcing fibers contained in the polymer composition can depend upon the particular application and the desired results. In general, reinforcing fibers can be present in the polymer composition in an amount from about 5% by weight to about 55% by weight, including all increments of 1% by weight therebetween. For instance, reinforcing fibers can be present in the polymer composition in an amount greater than about 10% by weight, such as in an amount greater than about 15% by weight, such as in an amount greater than about 20% by weight, such as in an amount greater than about 23% by weight. Reinforcing fibers can be present generally in an amount less than about 52% by weight, such as in an amount less than about 40% by weight, such as in an amount less than about 35% by weight.

The polymer composition can further contain a thermal cycling agent, such as a silicone polymer. The thermal cycling agent can not only compatibilize the different ingredients but can also increase the thermal shock resistance properties.

The thermal cycling agent can comprise a silicone. The silicone polymer can have any suitable molecular weight. In one aspect, the silicone polymer can be an ultra-high molecular weight silicone. In general, the UHMW-Si can have an average molecular weight of greater than 100,000 g/mol, such as greater than about 200,000 g/mol, such as greater than about 300,000 g/mol, such as greater than about 500,000 g/mol and less than about 3,000,000 g/mol, such as less than about 2,000,000 g/mol, such as less than about 1,000,000 g/mol, such as less than about 500,000 g/mol, such as less than about 300,000 g/mol. Generally, the UHMW-Si can have a kinematic viscosity at 40 °C measured according to DIN 51562 of greater than 100,000 mm²s⁻¹, such as greater than about 200,000 mm²s⁻¹, such as greater than about 1,000,000 mm²s⁻¹, such as greater than about 5,000,000 mm²s⁻¹, such as greater than about 10,000,000 mm²s⁻¹, such as greater than about 15,000,000 mm²s⁻¹ and less than about 50,000,000 mm²s⁻¹, such as less than about 25,000,000 mm²s⁻¹, such as less than about 10,000,000 mm²s⁻¹ such as less than about 1,000,000 mm²s⁻¹, such as less than about 500,000 mm²s⁻¹, such as less than about 200,000 mm²s⁻¹.

The UHMW-Silicone may comprise a siloxane such as a polysiloxane or polyorganosiloxane. In one embodiment, the UHMW-Si may comprise a dialkylpolysiloxane such as a dimethylsiloxane, an alkylarylsiloxane such as a phenylmethylsiloxane, a polysilsesquioxane, or a diarylsiloxane such as a diphenylsiloxane, or a homopolymer thereof such as a polydimethylsiloxane or a polymethylphenylsiloxane, or a copolymer thereof with the above molecular weight and/or kinematic viscosity requirements. The polysiloxane or polyorganosiloxane may also be modified with a substituent such as an epoxy group, a hydroxyl group, a carboxyl group, an amino group or a substituted amino group, an ether group, or a meth (acryloyl) group in the end or main chain of the molecule. The UHMW-Si compounds may be used singly or in combination. Any of the above UHMW-Si compounds may be used with the above molecular weight and/or kinematic viscosity requirements.

In one aspect, the silicone polymer is incorporated into the polymer composition as a master batch. The master batch can contain the silicone polymer combined with a carrier polymer. The carrier polymer can comprise a polymer compatible with the silicone polymer and compatible with the other polymers present in the composition. In one aspect, for instance, the carrier polymer can comprise a polyamide polymer. For instance, the carrier polymer can comprise an aliphatic polyamide polymer. The carrier polymer, for instance, can comprise polyamide 6, polyamide 66, or mixtures thereof.

The carrier polymer can be present in the master batch in an amount greater than about 20% by weight, such as in an amount greater than about 30% by weight, such as in an amount greater than about 40% by weight, and in an amount less than about 70% by weight, such as in an amount less than about 60% by weight, such as in an amount less than about 50% by weight. The silicone polymer can be present in an amount from about 30% by weight to about 80% by weight, including all increments of 1% by weight therebetween. For example, the silicone polymer can be present in the master batch in an amount greater than 30% by weight, such as in an amount greater than about 40% by weight, such as in an amount greater than about 50% by weight, and in an amount less than about 80% by weight, such as in an amount less than about 70% by weight.

The thermal cycling agent or silicone polymer is generally present in the polymer composition in amounts less than about 2% by weight. For instance, the thermal cycling agent can be present in the polymer composition in an amount less than about 1.75% by weight, such as in an amount less than about 1.6% by weight, such as in an amount less than about 1.5% by weight, such as in an amount less than about 1.25% by weight, such as in an amount less than about 1.1% by weight, such as in an amount less than about 0.9% by weight, such as in an amount less than about 0.7% by weight, such as in an amount less than about 0.5% by weight, such as in an amount less than about 0.4% by weight. The thermal cycling agent can be present in the polymer composition in an amount greater than about 0.08% by weight, such as in an amount greater than about 0.1% by weight, such as in an amount greater than about 0.15% by weight, such as in an amount greater than about 0.175% by weight.

The polymer composition of the present disclosure, in addition to one or more polyamide polymers, a flame retardant composition, reinforcing fibers, and a thermal cycling agent can contain various other components and ingredients. For instance, the polymer composition can contain a lubricant, coloring agents, and various different stabilizers.

In one aspect, for instance, the polymer composition can contain a lubricant. The lubricant can be present in the polymer composition in an amount from about 0.01% by weight to about 2% by weight. For instance, the lubricant can be present in an amount greater than about 0.08% by weight, such as in an amount greater than about 0.1% by weight, such as in an amount greater than about 0.15% by weight, and less than about 1% by weight, such as less than about 0.5% by weight.

The lubricant may be formed from a fatty acid salt derived from fatty acids having a chain length of from 22 to 38 carbon atoms, and in some embodiments, from 24 to 36 carbon atoms. Examples of such fatty acids may include long chain aliphatic fatty acids, such as montanic acid (octacosanoic acid), arachidic acid (arachic acid, icosanic acid, icosanoic acid, n-icosanoic acid), tetracosanoic acid (lignoceric acid), behenic acid (docosanoic acid), hexacosanoic acid (cerotinic acid), melissic acid (triacontanoic acid), erucic acid, cetoleic acid, brassidic acid, selacholeic acid, nervonic acid, etc. For example, montanic acid has an aliphatic carbon chain of 28 atoms and arachidic acid has an aliphatic carbon chain of 20 atoms. Due to the long carbon chain provided by the fatty acid, the lubricant has a high thermostability and low volatility. This allows the lubricant to remain functional during formation of the desired article to reduce internal and external friction, thereby reducing the degradation of the material caused by mechanical/chemical effects.

The fatty acid salt may be formed by saponification of a fatty acid wax to neutralize excess carboxylic acids and form a metal salt. Saponification may occur with a metal hydroxide, such as an alkali metal hydroxide (e.g., sodium hydroxide) or alkaline earth metal hydroxide (e.g., calcium hydroxide). The resulting fatty acid salts typically include an alkali metal (e.g., sodium, potassium, lithium, etc.) or alkaline earth metal (e.g., calcium, magnesium, etc.). Such fatty acid salts generally have an acid value (ASTM D 1386) of about 20 mg KOH/g or less, in some embodiments about 18 mg KOH/g or less, and in some embodiments, from about 1 to about 15 mg KOH/g. Particularly suitable fatty acid salts for use in the present invention are derived from crude montan wax, which contains straight-chain, unbranched monocarboxylic acids with a chain length in the range of C₂₈-C₃₂. Such montanic acid salts are commercially available from Clariant GmbH under the designations Licomont® CaV 102 (calcium salt of long-chain, linear montanic acids) and Licomont® NaV 101 (sodium salt of long-chain, linear montanic acids).

If desired, fatty acid esters may be used as lubricants. Fatty acid esters may be obtained by oxidative bleaching of a crude natural wax and subsequent esterification of the fatty acids with an alcohol. The alcohol typically has 1 to 4 hydroxyl groups and 2 to 20 carbon atoms. When the alcohol is multifunctional (e.g., 2 to 4 hydroxyl groups), a carbon atom number of 2 to 8 is particularly desired. Particularly suitable multifunctional alcohols may include dihydric alcohol (e.g., ethylene glycol, propylene glycol, butylene glycol, 1,3-propanediol, 1,4-butanediol, 1,6-hexanediol and 1,4-cyclohexanediol), trihydric alcohol (e.g., glycerol and trimethylolpropane), tetrahydric alcohols (e.g., pentaerythritol and erythritol), and so forth. Aromatic alcohols may also be suitable, such as o-, m- and p-tolylcarbinol, chlorobenzyl alcohol, bromobenzyl alcohol, 2,4-dimethylbenzyl alcohol, 3,5-dimethylbenzyl alcohol, 2,3,5-cumobenzyl alcohol, 3,4,5-trimethylbenzyl alcohol, p-cuminyl alcohol, 1,2-phthalyl alcohol, 1,3-bis(hydroxymethyl)benzene, 1,4-bis(hydroxymethyl)benzene, pseudocumenyl glycol, mesitylene glycol and mesitylene glycerol. Particularly suitable fatty acid esters for use in the present invention are derived from montanic waxes. Licowax® OP (Clariant), for instance, contains montanic acids partially esterified with butylene glycol and montanic acids partially saponified with calcium hydroxide. Thus, Licowax® OP contains a mixture of montanic acid esters and calcium montanate. Other montanic acid esters that may be employed include Licowax® E, Licowax® OP, and Licolub® WE 4 (all from Clariant), for instance, are montanic esters obtained as secondary products from the oxidative refining of raw montan wax. Licowax® E and Licolub® RWE 4 contain montanic acids esterified with ethylene glycol or glycerine.

Other known waxes may also be employed in a lubricant. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142 °C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl) 12-hydroxystearamide and N,N′-(ethylene bis)12-hydroxystearamide, which are commercially available from CasChem, a division of Rutherford Chemicals LLC, under the designations Paricin® 220 and Paricin® 285, respectively.

In one aspect, the polymer composition can further contain at least one stabilizer. The stabilizer can include, for instance, an antioxidant.

The antioxidant, for instance, can be a phenolic antioxidant. In one embodiment, for instance, the composition can contain a phenolic antioxidant. Examples of such phenolic antioxidants include, for instance, calcium bis(ethyl 3,5-di-tert-butyl-4-hydroxybenzylphosphonate) (Irganox® 1425); terephthalic acid, 1,4-dithio-, S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl) hydrazide (Irganox® 1024); 4,4′-di-tert-octyldiphenamine (Naugalube® 438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl) propionate (Irganox® 1135); octadecyl 3-(3,5-di-tert-butyl-4-hydroxyphenyl) propionate (Irganox® 1076); 3,7-bis(1,1,3,3-tetramethylbutyl)-10H-phenothiazine (Irganox® LO 3); 2,2′-methylenebis(4-methyl-6-tert-butylphenol) monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl) propionamide (Irganox® 1019); 4-n-octadecyloxy-2,6-diphenylphenol (Irganox® 1063); 2,2′-ethylidenebis[4,6-di-tert-butylphenol] (Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene)bis[3-(5-tert-butyl-4-hydroxy-m-tolyl)-propionate (Irganox® 245); 3,5-di-tert-butyl-4-hydroxytoluene (Lowinox BHT, Chemtura) and the like. In one embodiment, the antioxidant can be a reaction product of 2,4-di-tert-butylphenol, phosphorous trichloride, and 1,1′-biphenyl. In one aspect, the antioxidant comprises tetrakis(2,4-di-tert-butylphenyl)-4,4biphenyldiphosphonite. In one aspect, the antioxidant may comprises a phosphite. One example of a phosphite stabilizer is tris(2,4-di-tert-butylphenyl) phosphite.

In one aspect, an antioxidant may be present that is a hindered phenolic antioxidant. The hindered phenolic antioxidant, for instance, may comprise N,N′-(hexane-1,6-diyl)bis[3-(3,5-di-tert-butyl-4-hydroxyphenyl) propanamide].

One or more antioxidants can be present in the polymer composition generally in an amount greater than about 0.05% by weight, such as in an amount greater than about 0.08% by weight, such as in an amount greater than about 0.1% by weight, such as in an amount greater than about 0.2% by weight, such as in an amount greater than about 0.4% by weight, and generally less than about 2% by weight, such as less than about 1.5% by weight, such as less than about 1% by weight, such as less than about 0.8% by weight, such as less than about 0.5% by weight, such as less than about 0.4% by weight.

The composition can optionally include a light stabilizer which may comprise a hindered amine light stabilizer. Examples of light stabilizers that may be incorporated into the present disclosure include a benzenedicarboxamide. In one aspect, the light stabilizer comprises N,N′-Bis(2,2,6,6-tetramethyl-4-piperidinyl)-1,3-benzenedicarboxamide. The light stabilizer may also comprise any compound which is derived from an alkylsubtituted piperidyl, piperidinyl or piperazinone compound or a substituted alkoxypiperidinyl. Other suitable HALS are those that are derivatives of 2,2,6,6-tetramethyl piperidine. Preferred specific examples of HALS include: ~2,2,6,6-tetramethyl-4-piperidinone, ~2,2,6,6-tetramethyl-4-piperidinol, ~bis-(2,2,6,6-tetramethyl-4-piperidinyl)-sebacate, ~mixtures of esters of 2,2,6,6-tetramethyl-4-piperidinol and fatty acids, ~bis-(2,2,6,6-tetramethyl-4-piperidinyl)-succinate, ~bis-(1-octyloxy-2,2,6,6-tetramethyl-4-piperidinyl)-sebacate, ~bis-(1,2,2,6,6-pentamethyl-4-piperidinyl)-sebacate, ~tetrakis-(2,2,6,6-tetramethyl-4-piperidyl)-1,2,3,4-butane-tetracarboxylate, ~N-butyl-2,2,6,6-tetramethyl-4-piperidinamine, ~N,N′-bis-(2,2,6,6-tetramethyl-4-piperidyl)-hexane-1,6-diamine, ~2.2′-[(2.2.6.6-tetramethyl-4-piperidinyl)-imino]-bis-[ethanol], ~5-(2.2.6.6-tetramethyl-4-piperidinyl)-2-cyclo-undecyl-oxazole), ~mixture of: 2,2,4,4 tetramethyl-21-oxo-7-oxa-3.20-diazadispiro[5.1.11.2] heneicosane-20-propionic acid dodecylester and 2.2.4.4 tetramethyl-21-oxo-7; oxa-3,20-diazadispiro[5,1,11,2]-heneicosane-20-propionic acid; tetradecyl ester, ~diacetam 5 (CAS registration number: 76505-58-3), ~propanedioic acid, [(4-methoxyphenyl)methylene]-, bis(1,2,2,6,6-pentamethyl-4-piperidinyl) ester, ~1,3-benzendicarboxamide, N,N′-bis(2,2,6,6-tetramethyl-4-piperidinyl), ~3-dodecyl-1-(2,2,6,6-tetramethyl-4-piperidyl)-pyrrolidin-2,5-dione, ~formamide, N,N′-1,6-hexanediylbis [N-(2,2,6,6-tetramethyl-4-piperidinyl, ~3-dodecyl-1-(1,2,2,6,6-pentamethyl-4-piperidyl)-pyrrolidin-2,5-dione, ~1,5-Dioxaspiro (5,5) undecane 3,3-dicarboxylic acid, bis(2,2,6,6-tetramethyl-4-peridinyl) ester, ~1,5-Dioxaspiro (5,5) undecane 3,3-dicarboxylic acid, bis(1,2,2,6,6-pentamethyl-4-peridinyl) ester, ~bis (1,2,2,6,6-penta methyl-4-piperidyl) (3,5-di-t-butyl-4-hydroxybenzyl)-butylpropanedioate, ~tetrakis-(1,2,2,6,6-penta-methyl-4-piperidyl)-1,2,3,4-butane-tetra- -carboxylate, ~1,2,3,4-butanetetracarboxylic acid, tetrakis(2,2,6,6-tetramethyl-4-piperidinyl) ester, ~1,2,3,4-butane-tetracarboxylic acid-1,2,3-tris (1,2,2,6,6-pentamethyl-4-piperidinyl)-4-tridecylester, ~8-acetyl-3-dodecyl-7,7,9,9-tetra methyl-1,3,8-triazaspiro (4,5) decane-2,4-dione, ~N-2,2,6,6-tetrametyl-4-piperidinyl-N-amino-oxamide, ~4-acryloyloxy-1,2,2,6,6-pentamethyl-4-piperidine, ~1,5,8,12-tetrakis [2′,4′-bis(1″,2″,2″,6″,6″-pentamethyl-4″-piperidinyl(butyl)amino)-1′,3′,5′-tr-iazin-6′-yl]-1,5,8,12-tetraazadodecane, ~1,1′-(1,2-ethane-di-yl)-bis-(3,3′,5,5′-tetra-methyl-piperazinone) (Good rite 3034), ~propane amide, 2-methyl-N-(2,2,6,6-tetramethyl-4-piperidinyl)-2-[(2,2,6,6-tetramethyl-4-piperidinyl)amino], ~oligomer of N-(2-hydroxyethyl)-2,2,6,6-tetramethyl-4-piperidinol and succinic acid, ~poly [6-[(1,1,3,3-tetramethylbutyl)amino]-s-triazine-2,4-diyl][2,2,6,6-tetram-ethyl-4-piperidinyl)imino] hexamethylene [(2,2,6,6-tetramethyl-4-piperidinyl)imino]], ~poly [(6-morfoline-S-triazine-2.4-diyl) [(2.2.6.6-tetramethyl-4-piperidinyl)-imino]hexamethylene-[(2.2.6.6-tetram-ethyl-4-piperidinyl)-imino]], ~poly [(6-morpholino-s-triazine-2.4-diyl) [1.2.2.6.6-penta-methyl-4-piperidyl) imino]-hexamethylene [(2,2,6,6 tetra-methyl-4-piperidyl) imino]], ~poly methylpropyl-3-oxy-[4 (2.2.6.6-tetrametyl)-piperidinyl)]-siloxane copolymer of a-methylstyrene and n-(2.2.6.6-tetramethyl-piperidinyl)-4-maleimide and N-stearyl-maleimide, ~1,2,3,4-butane tetracarboxylic acid, polymer with 8,8,8′,8′-tetramethyl-2,4,8,10-tetraoxaspiro [5,5] undecane-3,9-diethanol, 1,2,2,6,6-pentamethyl-4-piperidinyl ester, ~1,2,3,4-butanetetracarboxylic acid, polymer with 8,8,8′,8′-tetramethyl-2,4,8,10-tetraoxaspiro[5,5] undecane-3,9-diethanol, 2,2,6,6-tetramethyl-4-piperidinyl ester, ~oligomer of 7-Oxa-3,20-diazadispiro[5,1,11,2] heneicosan-21-one, 2,2,4,4-tetramethyl-20-(oxiranylmethyl), ~1,3,5-Triazine-2,4,6-triamine, N, N″-[1,2-ethanediylbis [[[4,6-bis[butyl(1,2,2,6,6-pentamethyl-4-iperidinyl)amino]-1,3,5-triazine- -2-yl]imino]-3,1-propanediyl]]-bis [N. N″-dibutyl-N. N″-bis(1.2.2.6.6-pentamethyl-4-piperidinyl), ~1.3-Propanediamine, N, N-1,2-ethanediylbis-, polymer with 2,4,6-trichloro-1,3,5-triazine, reaction products with N-butyl-2,2,6,6-tetramethyl-4-piperidinamine, ~1.6-Hexanediamine, N,N′-bis(2,2,6,6-tetramethyl-4piperidinyl)-polymer with 2,4,6-trichloro-1,3,5-triazine, reaction products with N-butyl-1-butanamine and N-butyl-2,2,6,6-tetramethyl-4-piperidinamine, ~2,9,11,13,15,22,24,26,27,28-Decaazatricyclo[21,3,1,110,14]octacosa-1(27), 10,12,14(28),23,25-hexaene-12,25-diamine, N,N′-bis(1,1,3,3-tetramethylbutyl)-2,9,15,22-tetrakis (2,2,6,6-tetramethyl-4-piperidinyl)-, ~1,1,1″-(1,3,5-Triazine-2,4,6-triyltris ((cyclohexylimino)-2,1-ethanediyl) tris(3,3,5,5-tetramethylpiperazinone), ~1,1,1″-(1,3,5-Triazine-2,4,6-triyltris((cyclohexylimino)-2,1-ethylenediyl) tris(3,3,4,5,5-tetramethylpiperazinone), ~1,6-hexanediamine, N,N′-bis(2,2,6,6-tetramethyl-4-piperidinyl)-, polymer with 2,4,6-trichloro-1,3,5-triazine, reaction products with 3-bromo-1-propene, nbutyl-1-butanamine and N-butyl-2,2,6,6-tetramethyl-4-piperidinamine, oxidised, hydrogenated, ~Alkenes, (C20-24)-4 alpha-, polymers with maleic anhydride, reaction products with 2,2,6,6-tetramethyl-4-piperidinamine, ~N-2,2,6,6-tetramethyl-4-piperidinyl-N-amino-oxamide; 4-acryloyloxy-1,2,2,6,6-pentamethyl-4-piperidine; HALS PB-41 or mixtures thereof.

One or more light stabilizers can generally be present in the composition in an amount greater than about 0.01% by weight, such as in an amount greater than about 0.05% by weight, such as in an amount greater than about 0.08% by weight, and generally in an amount less than about 2% by weight, such as in an amount less than about 1% by weight, such as in an amount less than about 0.8% by weight, such as in an amount less than about 0.5% by weight, such as in an amount less than about 0.3% by weight, such as in an amount less than about 0.2% by weight.

In one embodiment, a coloring agent may optionally be incorporated into the polymer composition. The coloring agent, for instance, can be a black pigment such as carbon black or a black dye. The coloring agent can be present in the polymer composition in an amount greater than about 0.05% by weight, such as in an amount greater than about 0.1% by weight, and in an amount less than about 1.5% by weight, such as in an amount less than about 1% by weight, such as in an amount less than about 0.9% by weight.

A shaped part may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer composition for a desired time period to allow for solidification. The molded product may then be solidified by bringing it to a temperature below that of the melting temperature. The resulting product may be de-molded. The cycle time for each molding process may be adjusted to suit the polymer composition, to achieve sufficient bonding, and to enhance overall process productivity.

As indicated above, the unique properties of the polymer composition can more readily allow it to be integrally formed with a metal component having a vastly different thermal coefficient of expansion. Thus, if desired, the polymer composition may be employed in a composite structure that contains a metal component that is integrally formed and in contact with a resinous component that includes the polymer composition of the present invention. This may be accomplished using a variety of techniques, such as by an insert molding process in which the polymer composition is molded (e.g., injection molded) onto a portion or the entire surface of the metal component. The metal component may contain any of a variety of different metals, such as aluminum, stainless steel, magnesium, nickel, chromium, copper, titanium, and alloys thereof. Due to its unique properties, the polymer composition can adhere to the metal component by flowing within and/or around surface indentations or pores of the metal component. To improve adhesion, the metal component may optionally be pretreated to increase the degree of surface indentations and surface area. This may be accomplished using mechanical techniques (e.g., sandblasting, grinding, flaring, punching, molding, etc.) and/or chemical techniques (e.g., etching, anodic oxidation, etc.). In addition to pretreating the surface, the metal component may also be preheated at a temperature close to, but below the melt temperature of the polymer composition. This may be accomplished using a variety of techniques, such as contact heating, radiant gas heating, infrared heating, convection or forced convection air heating, induction heating, microwave heating or combinations thereof. In any event, the polymer composition is generally injected into a mold that contains the optionally preheated metal component.

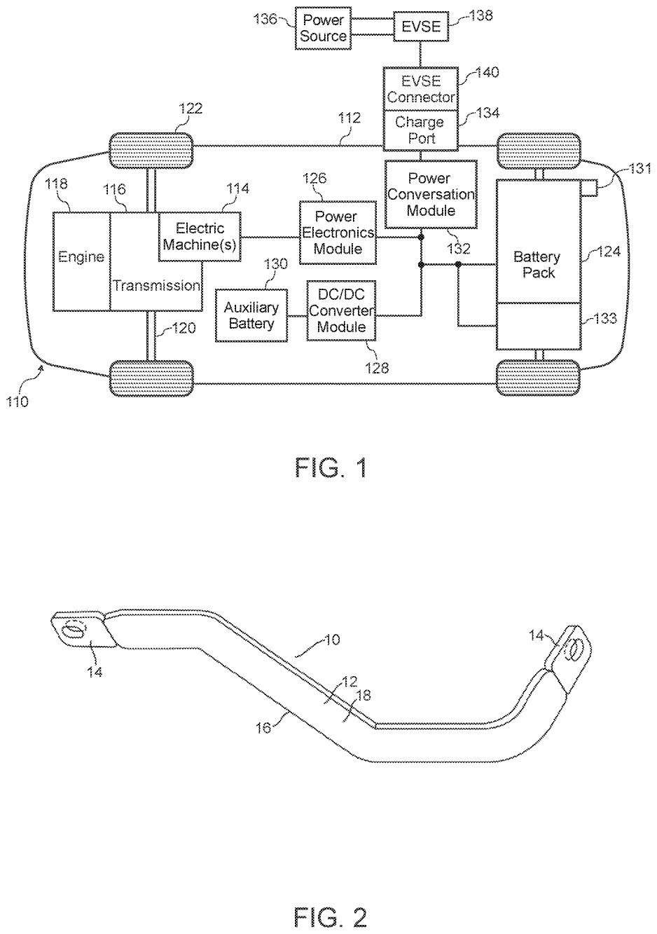

As previously mentioned, the polymer composition, shaped part, and/or composite structure are particularly beneficial for use in components of an electric vehicle. Referring to FIG. 1, for instance, one embodiment of an electric vehicle 112 that includes a powertrain 110 is shown. The powertrain 110 contains one or more electric machines 114 connected to a transmission 116, which in turn is mechanically connected to a drive shaft 120 and drive wheels 122. Although by no means required, the transmission 116 in this particular embodiment is also connected to an engine 118, though the description herein is equally applicable to a pure electric vehicle. The electric machines 114 may be capable of operating as a motor or a generator to provide propulsion and deceleration capability. The powertrain 110 also includes a propulsion source, such as a battery assembly 124, which stores and provides energy for use by the electric machines 114. The battery assembly 124 typically provides a high voltage current output (e.g., DC current at a voltage of from about 400 volts to about 800 volts) from one or more battery cell arrays that may include one or more battery cells.

The powertrain 110 may also contain at least one power electronics module 126 that is connected to the battery assembly 124 (also commonly referred to as a battery pack) and that may contain a power converter (e.g., converter, etc., as well as combinations thereof). The power electronics module 126 is typically electrically connected to the electric machines 114 and provides the ability to bi-directionally transfer electrical energy between the battery assembly 124 and the electric machines 114. For example, the battery assembly 124 may provide a DC voltage while the electric machines 114 may require a three-phase AC voltage to function. The power electronics module 126 may convert the DC voltage to a three-phase AC voltage as required by the electric machines 114. In a regenerative mode, the power electronics module 126 may convert the three-phase AC voltage from the electric machines 114 acting as generators to the DC voltage required by the battery assembly 124. The battery assembly 124 may also provide energy for other vehicle electrical systems. For example, the powertrain may employ a DC/DC converter module 128 that converts the high voltage DC output from the battery assembly 124 to a low voltage DC supply that is compatible with other vehicle loads, such as compressors and electric heaters. In a typical vehicle, the low-voltage systems are electrically connected to an auxiliary battery 130 (e.g., 12V battery). A battery energy control module (BECM) 133 may also be present that is in communication with the battery assembly 124 that acts as a controller for the battery assembly 124 and may include an electronic monitoring system that manages temperature and charge state of each of the battery cells. The battery assembly 124 may also have a temperature sensor 131, such as a thermistor or other temperature gauge. The temperature sensor 131 may be in communication with the BECM 133 to provide temperature data regarding the battery assembly 124. The temperature sensor 131 may also be located on or near the battery cells within the traction battery 124. It is also contemplated that more than one temperature sensor 131 may be used to monitor temperature of the battery cells.

In certain embodiments, the battery assembly 124 may be recharged by an external power source 136, such as an electrical outlet. The external power source 136 may be electrically connected to electric vehicle supply equipment (EVSE) that regulates and manages the transfer of electrical energy between the power source 36 and the vehicle 112. The EVSE 138 may have a charge connector 140 for plugging into a charge port 134 of the vehicle 112. The charge port 134 may be any type of port configured to transfer power from the EVSE 138 to the vehicle 112 and may be electrically connected to a charger or on-board power conversion module 132. The power conversion module 132 may condition the power supplied from the EVSE 138 to provide the proper voltage and current levels to the battery assembly 124. The power conversion module 132 may interface with the EVSE 138 to coordinate the delivery of power to the vehicle 112.

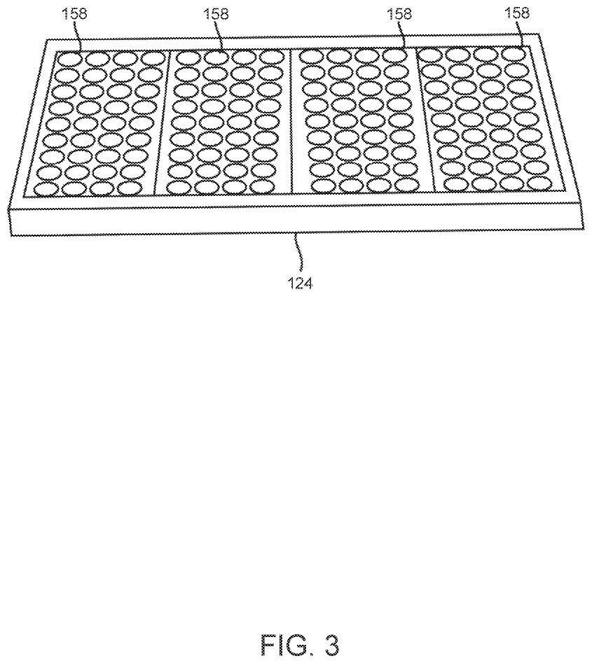

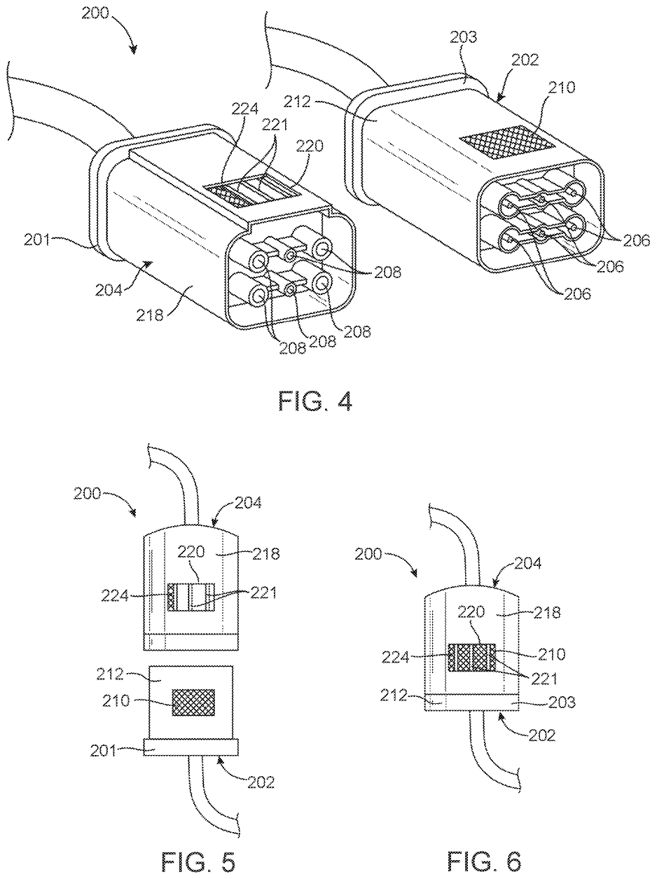

The polymer composition described herein can be included in various components of an electric vehicle as illustrated in FIG. 1. For instance, a busbar, one example of which is illustrated in FIG. 2, may be used to electrically connect individual cells of the battery assembly 124. Referring to FIG. 3, for example, the battery assembly 124 can include a number of battery cells 158. The battery cells 158 may be stacked side-by-side to construct a grouping of battery cells, sometimes referred to as a battery array. In one embodiment, the battery cells 158 are prismatic, lithium-ion cells. However, battery cells having other geometries (cylindrical, pouch, etc.) and/or chemistries (nickel-metal hydride, lead-acid, etc.) could alternatively be utilized within the scope of this disclosure. Each battery cell 158 includes a positive terminal (designated by the symbol (+)) and a negative terminal (designed by the symbol (−)). The battery cells 158 are arranged such that each battery cell 158 terminal is disposed adjacent to a terminal of an adjacent battery cell 158 having an opposite polarity. As used herein, the terms “battery”, “cell”, and “battery cell” may be used interchangeably to refer to any type of individual battery element used in a battery system. The batteries described herein typically include lithium-based batteries, but may also include various chemistries and configurations including iron phosphate, metal oxide, lithium-ion polymer, nickel metal hydride, nickel cadmium, nickel-based batteries (hydrogen, zinc, cadmium, etc.), and any other battery type compatible with an electric vehicle. For example, some embodiments may use the 6831 NCR 18650 battery cell from Panasonic®, or some variation on the 18650 form-factor of 6.5 cm×1.8 cm and approximately 45 g.

The manner in which a busbar connects to individual battery cells of a battery assembly 124, such as shown in FIG. 3, may vary as is known in the art. Referring to FIG. 2, one embodiment of a busbar 10 is shown that includes a conductive body 12. The body 12 includes a conductive material 18, such as copper, aluminum, aluminum alloy, etc., and can generally be in the form of a solid bar, hollow tube, and so forth. The busbar 10 includes a connector portion 14 at either end that is configured to mate with respective terminations of two or more batteries. An insulative portion 16 (e.g., coating or molded material) that includes the polymer composition as described herein may cover a portion of the conductive material of the body 12. To form the busbar 10, the insulative portion 16 can be applied to the surface of the conductive material 18. For instance, a bar or tube of the conductive material 18 can be inserted into a pre-formed tube of the insulating coating 16, e.g., an extruded tube sized and cut to the correct proportions, following which the busbar 10 can be shaped to any suitable form. In another embodiment, the insulating coating can be applied to the surface of the conductive material 18 in the melt, and can solidify on the surface of the conductive material in the applied areas.

Of course, a busbar may be provided in any suitable shape and size. For instance, a busbar may be used as a template for placing the individual battery cells so that they are uniform in each battery assembly manufactured. In such an embodiment, a busbar may hold individual batteries of a battery assembly 124 in place during the manufacturing process and thermal padding or injection-housings, which can be formed of a polymer composition as described herein, can be added without causing the individual battery cells to shift out of position.

Apart from busbars, other components may also employ the polymer composition of the present disclosure. For example, other components that can include the polymer composition of the present disclosure include current sensors, power electronic components, E-motor busbars, a component in an inverter system, or an electrical connector.

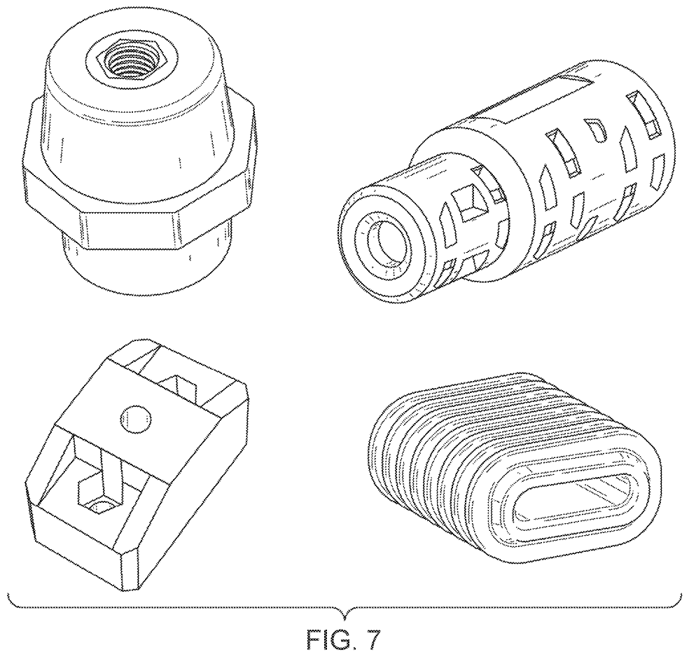

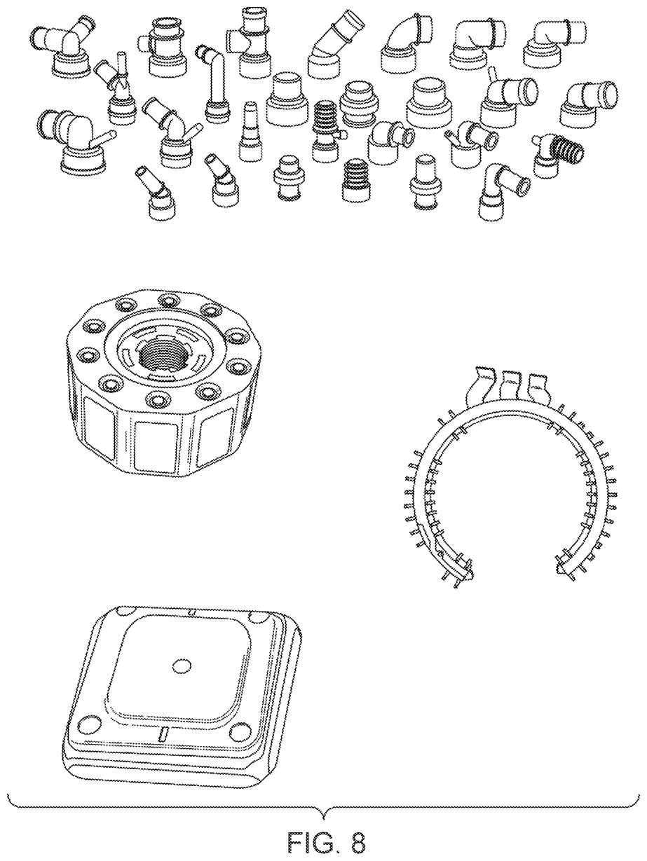

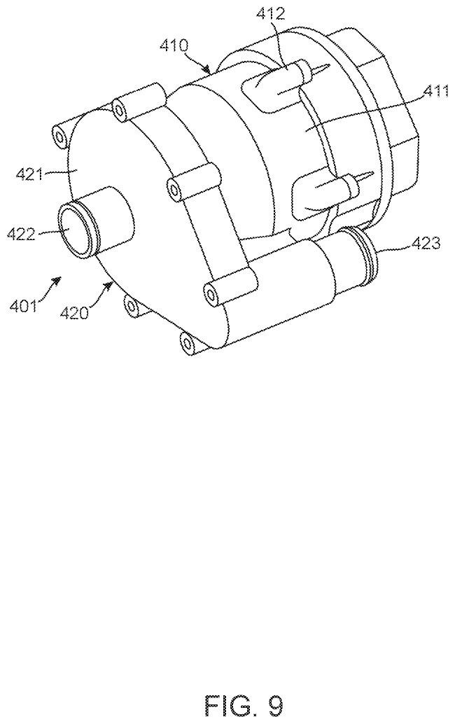

Referring to FIG. 4, FIG. 5, and FIG. 6, one particular embodiment of a connector 200 is shown for use in an electric vehicle, e.g., in an electric vehicle powertrain. The connector 200 contains a first connector portion 202 and a second connector portion 204. The first connector portion 202 may include one or more electrical pins 206 and the second connector portion 204 may include one or more receptacles 208 for receiving the electrical pins 206. A first insulator member 212 may extend from a base 203 of the first connecting portion 202 to surround the pins 206, and similarly, a second insulator member 218 may extend from a base 201 of the second connecting portion 204 to surround the receptacles 208. In certain cases, the periphery of the first insulator member 212 may extend beyond an end of the electrical pins 203 and the periphery of the second insulator member 218 may extend beyond an end of the receptacles 208. The base 203 and/or the first insulator member 212 of the first connector portion 202, as well as the base 201 and/or the second insulator member 218 of the second connector portion 204, may be formed from the polymer composition of the present invention.

Although by no means required, the first connector portion 202 may also include an identification mark 210 secured to or defined by the first protective member 212. The second connecting portion 204 may also optionally define an alignment window 220 sized according to the identification mark 210 to more easily determine when the portions are fully mated. For instance, the identification mark 210 may not be readable unless blockers 221 cover a portion of the identification mark 210. Optionally, the second connecting portion 204 may include a supplemental mark 224 located adjacent to the alignment window 220.

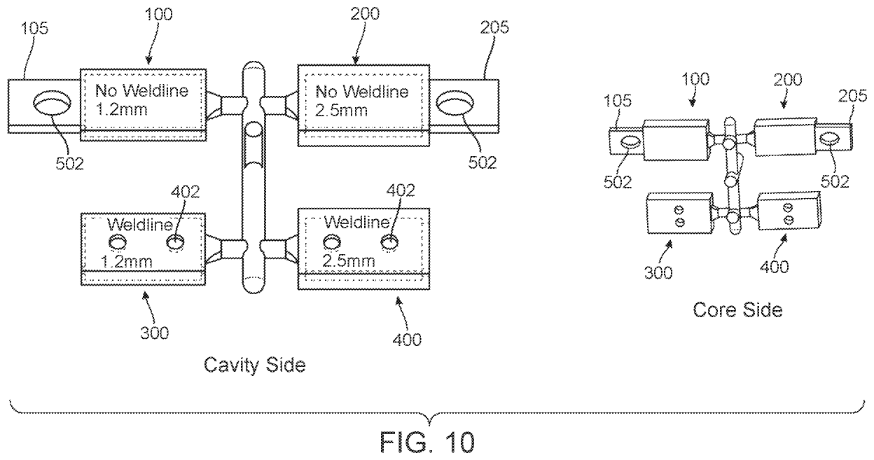

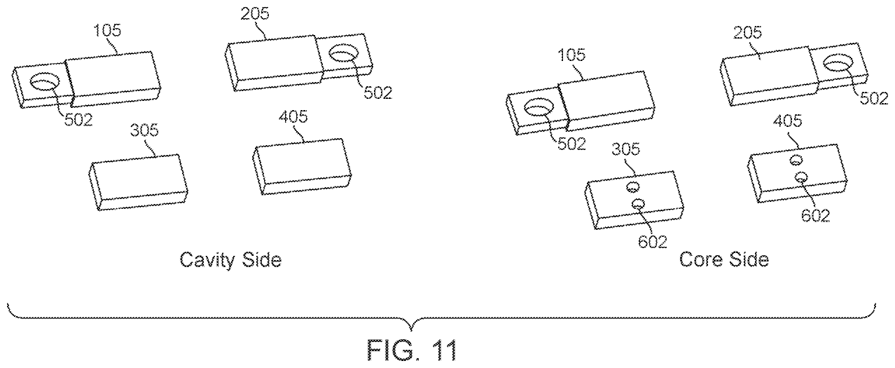

FIG. 7 and FIG. 8 illustrate yet other examples of components that may employ the polymer composition of the present invention, such as spacers, connectors, insulators and supports as shown in FIG. 7 and that can be formed from the polymer composition. Components as may incorporate a polymer composition illustrated in FIG. 8 include quick connects, tees, and interconnectors, a plurality of which are illustrated at the top of FIG. 8; brushless direct current motors (middle left of FIG. 8), e.g., sealing rings, housings, supports, etc. of a motor; guide rails (middle right of FIG. 8, also illustrating additional examples of busbars in the image); and battery sealing rings (bottom of FIG. 8).

Systems that can employ the polymer composition of the present invention are in no way limited to only electrical systems. For example, a thermal management system can also beneficially incorporate the polymer composition. A thermal management system of an electric vehicle can generally include multiple different subsystems such as, without limitation, a power train subsystem, a refrigeration subsystem, a battery cooling subsystem, and a heating, ventilation, and cooling (HVAC) subsystem. In some embodiments, one or more subsystems of a thermal management system may in fluid communication with one another, thus allowing hot heat transfer medium to flow from the high temperature circuit into the low temperature circuit, and cooler heat transfer medium to flow from the low temperature circuit into the high temperature circuit.

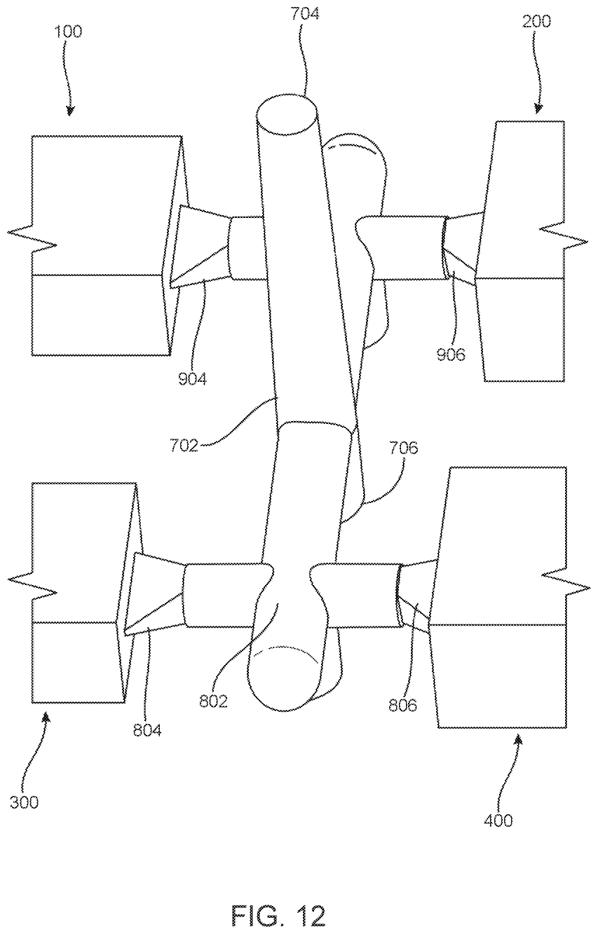

One example of a component of a heat management system as may incorporate the polymer composition of the invention is a coolant pump, e.g., an electric water pump, an example of which is illustrated in FIG. 9. As shown, the electric water pump 401 includes an electric motor 410 as a drive source and a hydraulic portion 420 for generating coolant suction and discharge forces. The motor 410 and associated components are retained with in the motor housing 411. The hydraulic portion 420 includes a volute casing 421 that generally includes a spiral flow space, an inlet 422, and outlet 423, and an impeller (not shown) rotated by the electric motor 410. The pump 401 has an interface including a mechanical seal (not shown), for sealing and separating the water flow space and the motor chamber. Generally, a mounting portion 412 is provided on the motor housing 411 to mount the pump 401 in the vehicle. Components of an electric pump 401 such as housings, casings, interfaces, etc. can incorporate a polymer composition of the invention.

The present disclosure may be better understood with reference to the following example.

### Example

Fiber-reinforced polymer compositions were formulated in accordance with the present disclosure and tested for various properties.

Each formulation contained a blend of polyamide 6 and polyamide 66. Two different polyamide 66 were used that each had different relative viscosities. The polyamide 66 used in Example Nos. 1-4 had a relative viscosity of 2.4 while the polyamide 66 used in Example No. 5 below had a relative viscosity of 2.7. Relative viscosity was measured according to Chinese national standard GB/T 38138-2019.

Two different types of glass fiber were also used. Example Nos. 1-3 and 5 used a glass fiber having a higher modulus.

Each of the formulations contained 15% by weight of a flame retardant composition. The flame retardant composition contained 63.5% by weight of aluminum diethylphosphonate, 32% by weight of melamine polyphosphate, and 4.5% by weight of zinc borate.

A thermal cycling agent in accordance with the present disclosure was also added to Example Nos. 2-5. Example No. 1 did not contain the thermal cycling agent for purposes of comparison.

The following compositions were formulated and the following results were obtained:

| Formulation | Example 1 | | Example 2 | | Example 3 | | Example 4 | | Example 5 | |
|---|---|---|---|---|---|---|---|---|---|---|
| Polyamide 66 (2.4 relative viscosity) | 40 | | 40 | | 40 | | 40 | | | |
| Polyamide 6 | 15 | | 15 | | 15 | | 15 | | 15 | |
| Polyamide 66 (2.7 relative viscosity) | | | | | | | | | 40 | |
| Glass Fiber | | | | | | | 30 | | | |
| Glass Fiber having higher modulus | 30 | | 30 | | 30 | | | | 30 | |
| Flame retardant composition | 15 | | 15 | | 15 | | 15 | | 15 | |
| Ultrahigh molecular weight | 0 | | 1 | | 2 | | 1 | | 1 | |
| polydimethylsiloxane masterbatch | | | | | | | | | | |
| (50% silicone and 50% PA6) | | | | | | | | | | |
| Sum | 100.0% | | 100.0% | | 100.0% | | | | 100.0% | |
| Properties | | | | | | | | | | |
| Flame retardancy, 1.5 mm | V-0 | | V-0 | | V-0 | | V-0 | | V-0 | |
| Comparative tracking index | 600 | V | 600 | V | 600 | V | 600 | V | 600 | V |
| Tensile modulus (5 mm/min) | 11000 | MPa | 10500 | MPa | 10500 | MPa | 11500 | MPa | 10500 | MPa |
| Tensile stress at break (5 mm/min) | 144 | MPa | 150 | MPa | 148 | MPa | 163 | MPa | 149 | MPa |
| Tensile strain at break (5 mm/min) | 2.4% | | 2.7% | | 2.7% | | 2.8% | | 2.9% | |
| Charpy notched impact strength (23 °C) | 8.9 | kJ/m² | 10.6 | kJ/m² | 10.2 | kJ/m² | 10.2 | kJ/m² | 10.3 | kJ/m² |

| | | | | | |
|---|---|---|---|---|---|
| Thermal shock resistance, 1^{st} crack | 312 | 792 | 360 | 624 | 624 |

As shown above, Example Nos. 2-5 all had increased thermal shock resistance in comparison to Example No. 1. Example No. 2 displayed the highest thermal shock resistance results when containing 0.5% by weight silicone polymer. When comparing Example No. 2 to Example No. 4, the higher modulus glass fibers also increased thermal shock resistance.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A polymer composition comprising:
a thermoplastic polymer, the thermoplastic polymer being present in the polymer composition in an amount greater than about 35% by weight, the thermoplastic polymer comprising one or more polyamide polymers;
a flame retardant composition contained within the polymer composition, the flame retardant composition comprising a non-halogen flame retardant;
reinforcing fibers dispersed throughout a polymer matrix formed from the thermoplastic polymer;
a thermal cycling agent comprising a silicone; and
wherein the polymer composition displays:
a comparative tracking index of at least 500 V,
a V-0 rating when tested according to Underwriters Laboratories Test 94 according to a Vertical Burn Test at a thickness of 1.5 mm; and
a thermal shock resistance of greater than about 450 cycles at a temperature range of from −40 °C to 140 °C.

2. A polymer composition as defined in claim 1, wherein the polymer composition displays a comparative tracking index of at least 525 V.

3. A polymer composition as defined in claim 1, wherein the polymer composition displays a thermal shock resistance of greater than about 500 cycles at a temperature range of from −40 °C to 140 °C.

4. A polymer composition as defined in claim 1, wherein the thermal cycling agent comprises an ultra-high molecular weight silicone and is present in the polymer composition in an amount from about 0.1% by weight to about 1.75% by weight.

5. A polymer composition as defined in claim 4, wherein the ultra-high molecular weight silicone comprises a polydimethylsiloxane.

6. A polymer composition as defined in claim 1, wherein the silicone is added to the polymer composition as a masterbatch comprising the silicone combined with a carrier polymer.

7. A polymer composition as defined in claim 6, wherein the carrier polymer comprises a polyamide.

8. A polymer composition as defined in claim 1, wherein the reinforcing fibers comprise glass fibers.

9. A polymer composition as defined in claim 8, wherein the reinforcing fibers have an average fiber length of from about 1 mm to about 5 mm and have an average fiber diameter of from about 8 microns to about 15 microns.

10. A polymer composition as defined in claim 8, wherein the glass fibers are present in the polymer composition in an amount from about 5% to about 55% by weight.

11. A polymer composition as defined in claim 8, wherein the glass fibers contain silicon dioxide in an amount greater than 60% by weight.

12. A polymer composition as defined in claim 8, wherein the glass fibers contain aluminum oxide in an amount greater than 16% by weight, contain boron oxide in an amount less than 5% by weight, and contain magnesium oxide in an amount of from about 3% by weight to about 10% by weight.

13. A polymer composition as defined in claim 1, wherein the flame retardant comprises a metal phosphinate.

14. A polymer composition as defined in claim 1, wherein the polymer composition further contains a nitrogen-containing synergist for the flame retardant.

15. A polymer composition as defined in claim 1, wherein the one or more polyamide polymers comprise an aliphatic polyamide polymer.

16. A polymer composition as defined in claim 1, wherein the one or more polyamide polymers comprise polyamide 66, polyamide 6, or mixtures thereof.

17. A polymer composition as defined in claim 1, wherein the one or more polyamide polymers comprise a mixture of polyamide 66 and polyamide 6, the polyamide 66 being present in the polymer composition in an amount of from about 25% by weight to about 60% by weight, the polyamide 6 being present in the polymer composition in an amount of from about 5% by weight to about 25% by weight.

18. A polymer composition as defined in claim 1, wherein the polymer composition exhibits a V-0 rating as determined in accordance with UL94 testing at a thickness of 0.8 mm and exhibits a notched Charpy impact resistance of greater than about 9 kJ/m² and a tensile stress at break of greater than about 145 MPa.

19. (canceled)

20. A composite structure comprising a metal component in contact with a resinous component that includes the polymer composition of claim 1.

21. (canceled)

22. The composite structure of claim 20, wherein the composite structure comprises a busbar, current sensor, inverter filter, electrical connector, a brushless direct current motor, a guide ring, a battery cell sealing ring, a quick connector, a tee, an interconnector, an electrical connector or a combination thereof.

23. (canceled)
